(19) United States
(12) Patent Application Publication
(10) Pub. No.: US 2026/0200000 A1
(43) Pub. Date: Jul. 16, 2026

(54) POWER SOURCE ENCLOSURE

(71) Applicant: Lincoln Global, Inc., Cleveland, OH (US)

(72) Inventors: Didier Borrego, Vineuil Saint Firmin (FR); Pawel Greiner, Bielawa (PL)

(21) Appl. No.: 19/354,935

(22) Filed: Oct. 10, 2025

Related U.S. Application Data
(60) Provisional application No. 63/706,838, filed on Oct. 14, 2024.

(51) Int. Cl. B23K 9/32

(52) U.S. Cl. CPC B23K 9/32

(57) ABSTRACT

A power source for a welding or cutting application includes an enclosure defining an internal cavity for housing electronics. The enclosure includes a plurality of panels including at least a top panel and a side panel. The top panel includes a tray defining a storage area. A drainage opening is formed through the tray to allow liquid in the tray to drain therethrough.

### CROSS-REFERENCE TO RELATED APPLICATIONS

This U.S. patent application claims priority to and the benefit of U.S. provisional patent application serial no. 63/706,838, filed on October 14, 2024, the disclosure of which is incorporated herein by reference in its entirety.

### TECHNICAL FIELD

The present invention relates to enclosures for welding or cutting power sources, and more particularly, a power source enclosure with an integrated storage tray and drainage system therefor.

### BACKGROUND OF THE INVENTION

Tradespeople such as welders and fabricators often require immediate access to tools and consumable components, including replacement welding or cutting torch parts such as contact tips, tungsten electrodes, plasma cutting electrodes, and other related items. Such tools or components are typically stored in designated areas, such as beneath a work bench, within a welding cart or undercarriage (e.g., in a drawer thereof), or within a storage cabinet. However, when such items are stored out of sight, they are frequently misplaced or forgotten, leading to inefficiencies and interruptions in production.

Additionally, it is common for tradespeople to place beverages or other items on top of welding or cutting power sources. This practice poses a risk of spillage, which can result in moisture ingress into the power source, thereby damaging internal electronics or mechanical components. Moreover, such power sources are often used in environments where exposure to moisture is unavoidable, such as outdoor settings or in a factory during washdowns procedures, further increasing the risk of internal damage.

Another challenge associated with conventional power sources is the difficulty of accessing internal components for maintenance, repair, or software updates. Many existing enclosures require the removal of multiple fasteners and panels, which increases service time and contributes to equipment downtown. Accordingly, there is a need for an improved power source enclosure that facilitates convenient access to tools and consumables, protects internal components from moisture exposure, and enables efficient servicing of internal electrical or mechanical components.

### BRIEF SUMMARY OF THE INVENTION

The following summary presents a simplified summary in order to provide a basic understanding of some aspects of the power sources and/or systems discussed herein. The present disclosure is directed to an improved power source enclosure architecture designed to enhance part or component access, serviceability, and durability in demanding work environments. The enclosure provides an integrated storage tray for tools and consumables, enabling tradespeople to maintain immediate access to essential components during operation. Additionally, the enclosure incorporates features that mitigate the risk of moisture ingress, thereby protecting internal electronics and mechanical components from environmental exposure. The present disclosure further facilitates maintenance and repair activities by enabling simplified access to internal components.

It should be understood that this summary is not an extensive overview of the power source enclosures and/or systems discussed herein. It is not intended to identify critical elements or to delineate the scope of such enclosures and/or systems. Its sole purpose is to present some concepts in a simplified form as a prelude to the more detailed description that is presented later.

In accordance with an aspect, there is provided a power source including an enclosure defining an internal cavity for housing electronics. The enclosure includes a plurality of panels including a top panel and a side panel. The top panel includes a tray defining a storage area, and a drainage opening is formed through the tray. The drainage opening is configured to allow liquid within the tray to drain therethrough and be directed out of the tray.

In an embodiment, the enclosure includes a channel adjacent to the side panel and fluidly connected to the drainage opening. The channel is configured to direct the liquid toward an exterior of the power source.

In an embodiment, the enclosure includes a partition wall attached to the side panel. The partition wall and the side panel at least partly define the channel.

In an embodiment, the enclosure includes a partition wall attached to the side panel. The partition wall defines an opening extending between an internal cavity of the power source and the channel.

In an embodiment, the top panel includes a flange extending downward therefrom. The flange includes a first segment extending downward from the top panel, a second segment extending inward from the first segment, and a third segment bent relative to the second segment.

In an embodiment, the side panel includes a bent lip at an upper end thereof, and the top panel includes a flange extending downward therefrom. The bent lip and the flange at least partly define the channel.

In an embodiment, the tray is recessed relative to an upper surface of the top panel.

In an embodiment, at least one connector is disposed on a wall of the recessed tray. The connector is operatively connected to the electronics within the enclosure and is configured to provide at least one of data communication or power delivery to an external device.

In an embodiment, the tray includes a bottom wall and a plurality of walls extending upwardly therefrom that collectively define the storage area. And the drainage opening comprises a slot formed adjacent a junction of the bottom wall and one of the plurality of walls.

In an embodiment, the side panel includes a tab at an upper end thereof, and the top panel includes a flange extending downward therefrom. The flange defines an opening, and the tab is dimensioned and configured to be received by the opening of the flange to removably attach the side panel to the power source.

In an embodiment, the channel further includes a tube extending from the drainage opening to a discharge port formed through the side panel of the enclosure.

In accordance with another aspect, there is provided a welding system including a power source and a welding torch operatively connected to the power source. The power source is configured to supply a welding current or laser beam, and the power source includes an enclosure. The enclosure includes at least a top panel and a side panel that at least partly define an internal cavity of the power source. A tray is attached to the top panel and defines a drainage opening for liquid therethrough. The welding torch is configured to emit the welding current or the laser beam.

In an embodiment, the enclosure includes a partition wall in the internal cavity attached to the side panel. The partition wall and the side panel at least partly define a channel fluidly connected to the drainage opening.

In an embodiment, the welding system also includes a cooler operatively connected to the welding torch. The cooler is configured to cool and recirculate a coolant to the welding torch.

In an embodiment, the welding system also includes a controller. The controller includes logic to receive a temperature measurement of the coolant, and control a run time of the cooler based on the temperature measurement.

In an embodiment, the controller further includes logic to extend the cooler run time after termination of a weld or when the temperature measurement of the coolant exceeds a threshold.

In an embodiment, the cooler includes a docking port configured to operatively connect to the power source to receive power therefrom and to transmit the temperature measurement therebetween.

In an embodiment, the tray further includes a friction surface disposed on the bottom wall to prevent items from sliding within the tray.

In an embodiment, the tray further includes a wireless charging surface integrated into a bottom wall thereof.

In an embodiment, a flange extends downward from the top panel. The flange includes a first segment extending downward from the top panel, a second segment extending inward from the first segment, and a third segment bent outward relative to the second.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 shows a welding system with an example power source, in accordance with an embodiment;

FIG. 2 is a top, perspective view of the power source of FIG. 1;

FIG. 3 is a partial, sectional view of the power source of FIG. 1, taken along line A-A of FIG. 1;

FIG. 4 is an enlarged view of the area demarcated by dotted lines in FIG. 3;

FIG. 5 is a partial, sectional view of the power source of FIG. 1, taken along line B-B of FIG. 1;

FIG. 6 is a bottom, perspective view of the power source of FIG. 1;

FIG. 7 is a partial bottom, exploded view of the power source of FIG. 1 with a side panel thereof removed therefrom;

FIG. 8 illustrates a welding system with an example power source and cooler, in accordance with another embodiment; and

FIG. 9 is a partial, sectional view of the power source of FIG. 8, taken along line C-C of FIG. 8; and

FIG. 10 is a schematic illustration of the welding system of FIG. 8.

### DETAILED DESCRIPTION OF THE INVENTION

The present disclosure relates to power source enclosures, and more particularly, a power source enclosure with an integrated storage tray and passive drainage system to facilitate the removal of accumulated moisture from the storage tray.

The present disclosure will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present disclosure. It may be evident, however, that the present disclosure may be practiced without these specific details. Additionally, other embodiments of the present disclosure are possible and the various examples of inventions disclosed herein are capable of being practiced and carried out in ways other than as described. The terminology and phraseology used in describing the present disclosure is employed for the purpose of promoting an understanding of the various inventions disclosed herein and should not be taken as limiting.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. Any disjunctive word or phrase presenting two or more alternative terms, whether in the description of embodiments, claims, or drawings, should be understood to contemplate the possibilities of including one of the terms, either of the terms, or both terms. For example, the phrase “A or B” should be understood to include the possibilities of “A” or “B” or “A and B.”

“Controller,” as used herein, refers to the logic circuitry and/or processing elements and associated software, programs, or artificial intelligence models utilized to execute the disclosed methodologies and systems disclosed herein. The controller may include a processor and a storage device, and may take on various forms, for example, a workstation, server, computing cluster, blade server, server farm, or any other data processing system or computing device. Due to the ever-changing nature of computing devices and networks, the description of the various examples of a controller described herein, and depicted in the associated drawings, is intended only as an example for purposes of illustrating some embodiments. Many other configurations of the controller are contemplated to fall within the scope of the present disclosure.

“Logic,” synonymous with “circuit” as used herein, includes but is not limited to hardware, firmware, software and/or combinations of each to perform a function(s) or an action(s). For example, based on a desired application or needs, logic may include a software-controlled microprocessor, discrete logic such as an application specific integrated circuit (ASIC), or other programmed logic device and/or controller. Logic may also be fully embodied as software.

“Software,” as used herein, includes but is not limited to, one or more computer readable and/or executable instructions (e.g., stored on local machine readable media or on a server) that cause a computer, processor, logic, and/or other electronic device to perform functions, actions, and/or behave in a desired manner. The instructions may be embodied in various forms such as routines, an algorithm, an artificial intelligence model, modules, or programs including separate applications or code from dynamically linked sources or libraries.

Although embodiments of the present disclosure are described in the context of a gas tungsten arc welding (GTAW) system, the inventive concepts disclosed herein are broadly applicable to other types of welding and material deposition systems. These include, but are not limited to, gas metal arc welding (GMAW), flux-cored arc welding (FCAW), metal-cored arc welding (MCAW), and similar technologies. Furthermore, the various inventions disclosed herein may be utilized in non-traditional welding applications such as additive manufacturing, hardfacing, and cladding. As used herein, the term “welding” is intended to encompass all such material deposition processes, regardless of whether they involve joining multiple workpieces. The disclosed inventions may also be applicable to laser welding systems, plasma cutting systems, and other related technologies.

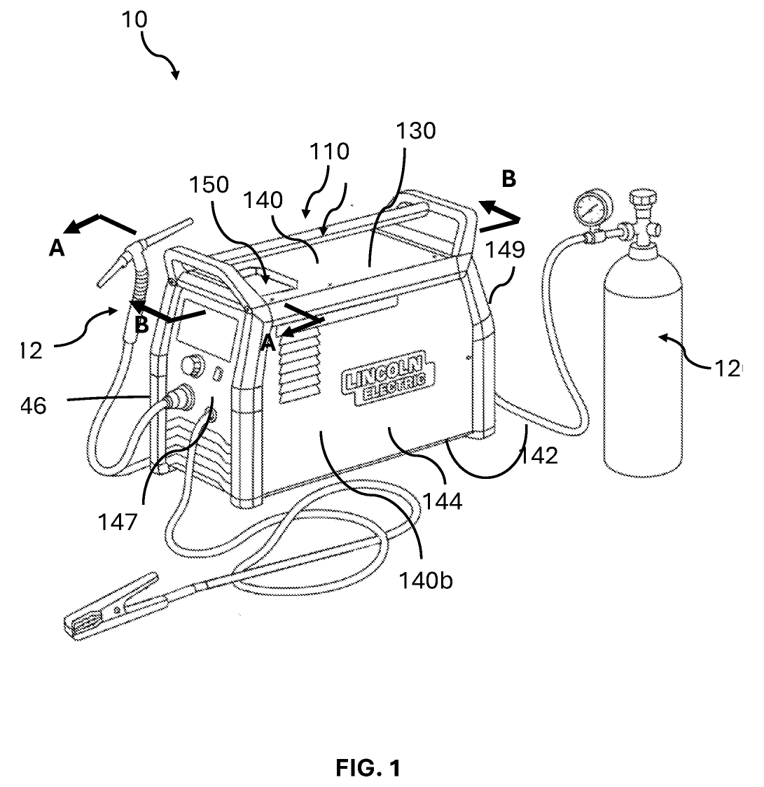

Referring now to FIG. 1, an exemplary embodiment of a GTAW welding system 10 is shown. The system includes a welding power source 110 (i.e., a welding power supply) configured to supply welding current to a downstream welding torch 112 via a power cable extending therebetween. Because the internal controls, power output components, and devices for generating and controlling the welding output are generally known, they are not described in detail herein. Further, in certain embodiments, the welding system may include wire feeding systems for advancing a filler wire or consumable electrode to a weld puddle during a welding operation, which are likewise known and not further described herein.

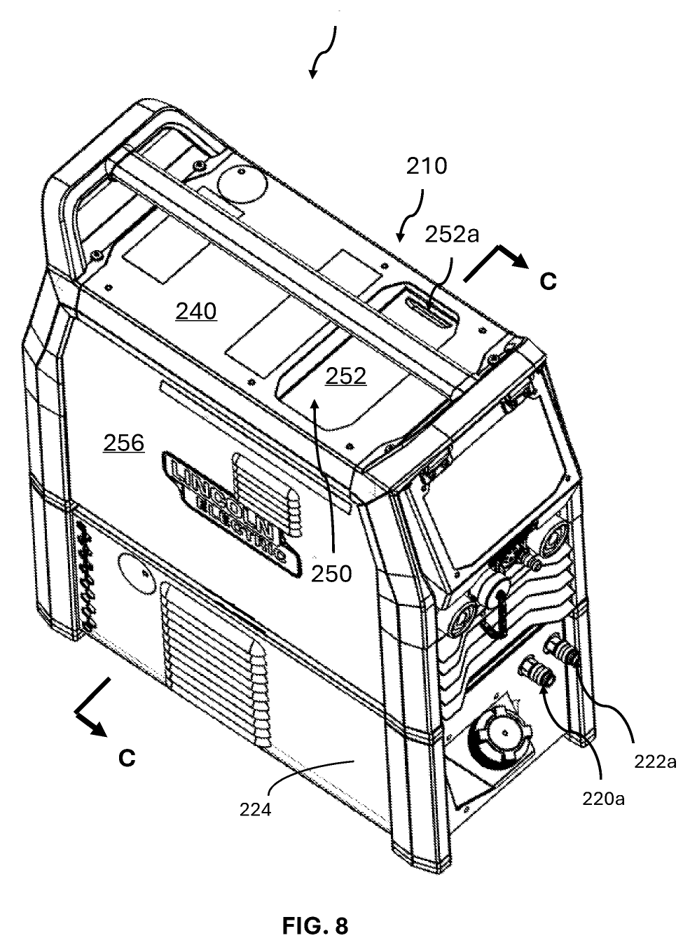

In the embodiment shown, the system also includes a shielding gas source 120 which is connected to the power source 110 via a gas supply line, enabling the supply of shielding gas to the torch 112 during operation. The power source 110 may also include various user input controls and display interfaces. Further still, the system may include a cooler (e.g., 224 in FIG. 8) comprising a heat exchanger (not shown) configured to extract heat from coolant circulated to and from the torch 112. For purposes of this disclosure, the term “power source” refers to any source configured to provide energy or light for a welding or cutting operation, including (i) a laser source for generating a welding laser beam, (ii) an electrical power source for generating welding current, and (iii) a power source for generating an arc to ionize gas for plasma cutting.

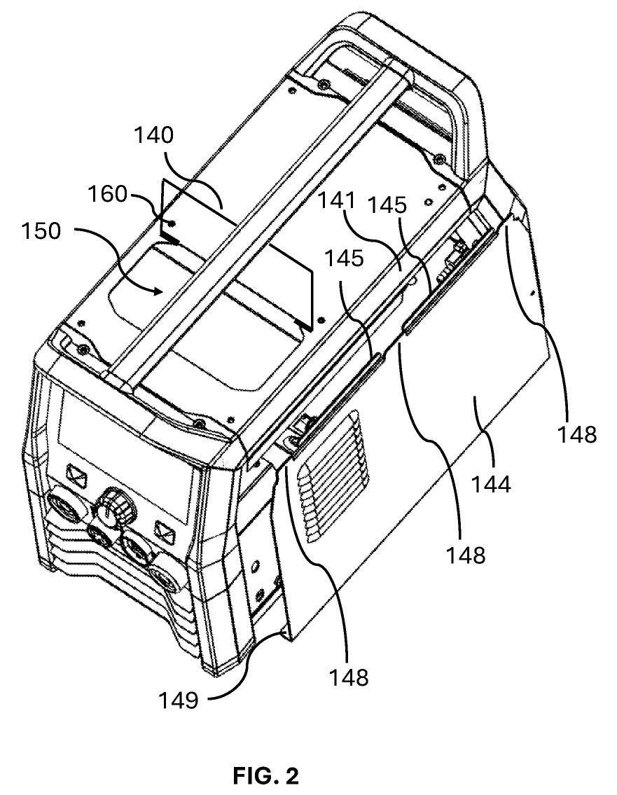

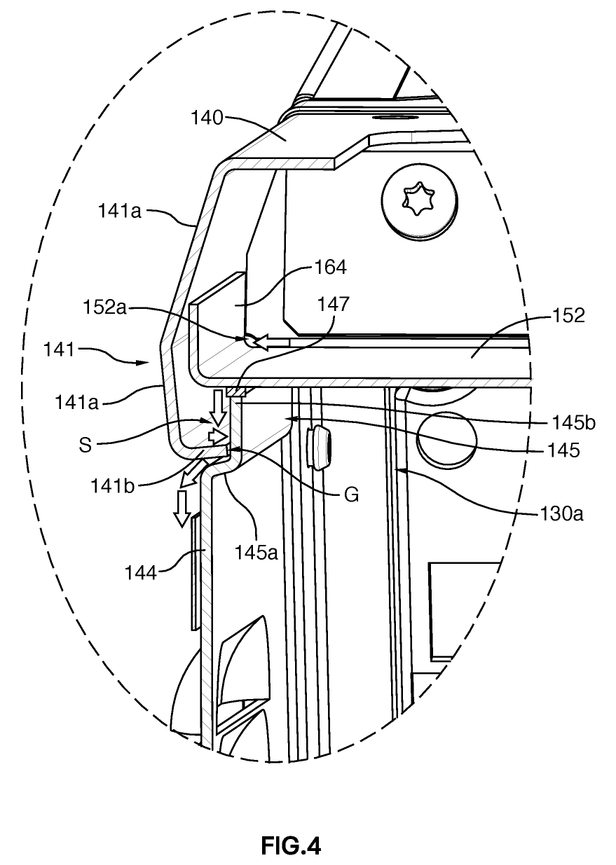

As shown in FIGS. 1 and 2, the power source 110 includes an enclosure 130 defining an internal cavity 130a (FIG. 4) therein. The cavity 130a may be dimensioned to house and retain various internal components or electronics, such as one or more controllers, welding output circuitry, and user-interface circuitry, etc.

The enclosure 130 may comprise a plurality of walls or panels defining and enclosing the cavity 130a. In particular, the plurality of panels may include a top panel 140, a bottom panel 142, a first side panel 144, a second side panel 146, a front panel 147, and a rear panel 149.

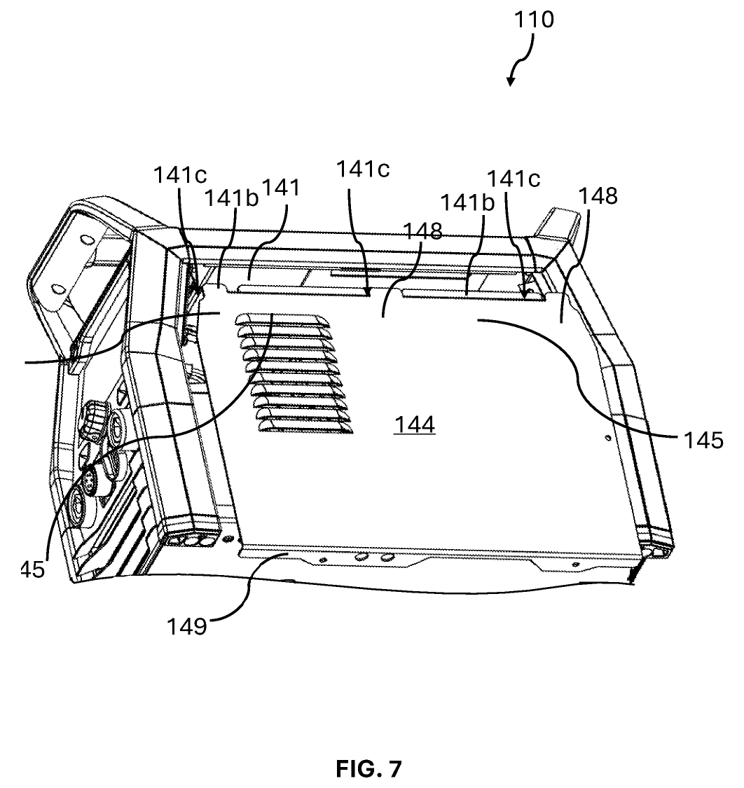

As shown in FIG. 2, each side panel 144 or 146 may include one or more tabs 148 projecting from an upper end thereof. Each tab 148 may be dimensioned and positioned to engage a corresponding slot 141c (FIG. 7), as discussed in detail below. Each side panel 144 or 146 may further include a bent leg 149 projecting inwardly from a lower end thereof that is configured to engage a bottom of the power source 110, as discussed in detail below.

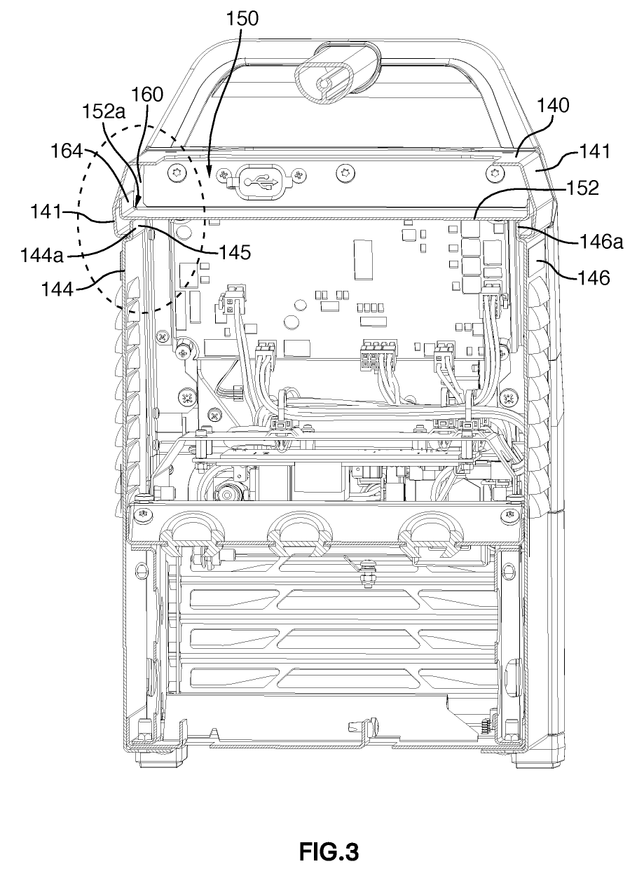

As shown in FIGS. 3 and 4, each side panel 144 or 146 may also include an inwardly bent lip 145 projecting from an upper end thereof. As shown in FIG. 4, each lip 145 may include a first or bent segment 145a extending generally inward, and a second or vertical segment 145b extending generally upward from the bent segment 145a (e.g., such that the vertical segment 145b is disposed substantially parallel with the respective side panel).

As further shown in FIGS. 3 and 4, the top panel 140 may include flanges 141 projecting downward therefrom and toward the first and second side panels 144 and 146, respectively. As shown in FIG. 4, each flange 141 may include a first segment 141a projecting downward from the top panel 140 and at least partially defining a space S between the flange 141 and the bent lip 145. Each flange 141 may further include a second segment 141b extending inward (toward the internal cavity 130a) from a lower end of the first segment 141a, thereby further defining the space S. A gap G may be defined between a distal end of the second segment 141b and the bent lip 145 to partly define a drainage channel 180, as discussed in detail below. As shown in FIG. 7, each flange 141 may also define one or more openings or slots 141c dimensioned and positioned to engage with the tabs 148 of the side panel. In the embodiment shown, the slots 141c are defined by the second segment 141b of the flange 141. In other embodiments, the slots 141c may alternatively be defined by a chassis or frame of the power source.

Turning back to FIG. 2, the top panel 140 may also include a recessed tray 150 extending beneath an upper surface thereof. The tray 150 may be dimensioned and configured to accommodate a variety of tools and/or components (e.g., welding torch or welding gun components, such as contact tips, nozzles, collets, diffusers, tungsten, or plasma torch consumables (e.g., electrodes, shields, etc.)) for convenient access during welding or cutting operations. It is also contemplated that the tray 150 may be used to store additional items, for example, welding gloves, a smartphone, a tablet, or even a beverage container (e.g., water or soda).

As shown in FIG. 2, in some embodiments, a cover 160 (see, e.g., FIG. 2) may be rotatably attached to the top panel 140 (e.g., via a hinge or other form of a pivot) to provide additional protection against environmental exposure, such as dust or moisture. In other embodiments, the cover 160 may be removably secured to the top panel 140, for example, via resilient snaps or tabs, for example, tab and slot configuration.

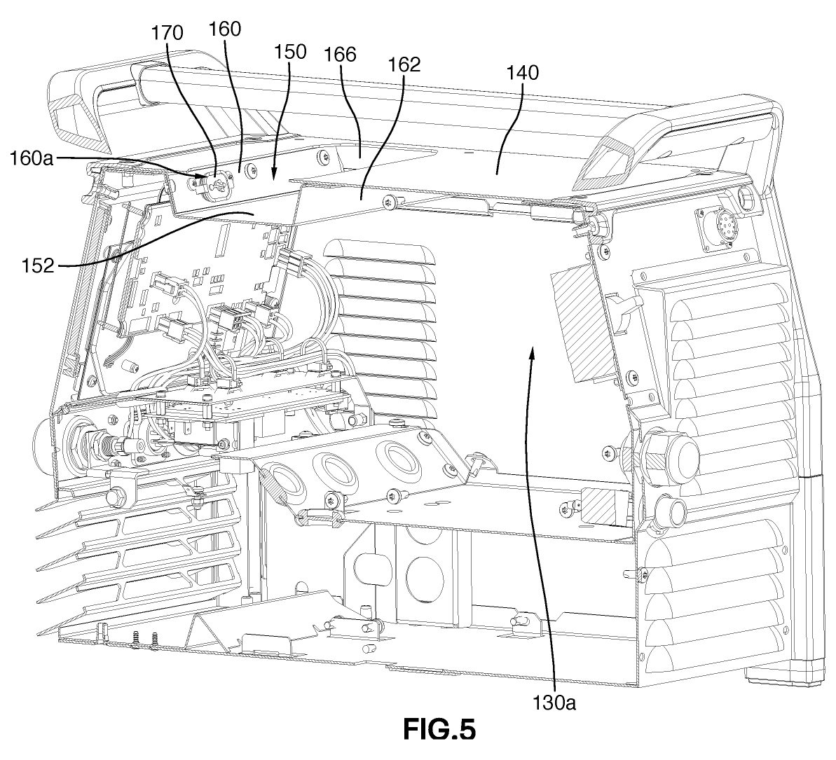

As shown in FIGS. 3 and 5, the tray 150 may include a bottom wall 152 recessed relative to the top panel 140 via a plurality of walls extending therebetween. In the embodiment shown, the plurality of walls includes a front wall 160, a rear wall 162, a first side wall 164, and a second side wall 166. In some embodiments, the bottom wall 152 may embody a piece of sheet metal that is bent to define the surrounding walls 160-166. Together, the walls 160-166 and the bottom wall 152 may define a storage area of the recessed tray 150.

In some embodiments, one or more openings may extend through the recessed tray 150. For instance, the front wall 160 may define an opening 160a configured to receive and retain universal serial bus (USB) connector 160 therefrom. The USB connector 160 may be configured to facilitate data communication (e.g., software updates) and/or power delivery between the power source 110 and an external peripheral device, e.g., a smart phone, tablet, or laptop. The USB interface connector 170 may be of any suitable type, including but not limited to USB Type-A, USB Type-B, USB Micro-B, USB Mini-B, or USB Type-C, connector and may conform to one or more USB standards, such as USB 2.0, USB 3.0, USB 3.1, USB 3.2, or USB4.

The USB connector 170 may embody a physical connector mounted to the recessed tray 150 and operatively coupled to the internal electronics of the power source 110 (e.g., to at least one of a controller circuit board, USB circuit board, or power output board, etc.). In this manner, the USB connector 170 may facilitate software updates and/or function as a charging port for external accessories (e.g., for a smart phone, tablet, tungsten grinder, etc.). The USB connector 170 may further include circuitry for managing data transfer protocols, power negotiation, and device identification. In the embodiment shown, the USB connector 170 is disposed on the front wall 160 of the recessed tray 150. It is contemplated that the USB connector may be disposed on other walls of the recessed tray, for example, on any one of the side walls 164, 166 or the rear wall 162. In certain embodiments, there may be more than one USB connector 170. In some embodiments, the recessed tray 150 may include a capacitive wireless charger (e.g., integrated into the bottom wall thereof) to wirelessly charge an external accessory such as a smart phone or a tablet.

In some embodiments, the bottom wall 152 may define an impediment surface thereon, for example, a high-friction material such as a rubber inlay (e.g., rubber or silicone) to prevent items stored in the recessed tray 150 from sliding (e.g., to prevent a beverage container or other item from shifting relative thereto).

The bottom wall 152 (i.e., bottom surface of the tray) may also define one or more inlet ports fluidly connected to an external environment via a fluid channel 180 (i.e., a conduit defining a fluid pathway). This aspect of the present disclosure is particularly beneficial to direct liquid (e.g., water or a spilled beverage) accumulated in the tray 150 to the external environment (e.g., toward an exterior of the power source), e.g., to prevent liquid accumulation that may otherwise cause fluid ingress into the machine that would potentially damage one or more components therein. Thus, the tray 150 can include one or more drainage openings (i.e., weep holes) to drain water out of the tray 150.

For example, as shown in FIGS. 3 and 4, one or more drainage openings (e.g., through holes) 152a may be formed through the recessed tray 150, for example, at a junction of the front wall 160 and the side wall 164. Although, it should be understood that the through-holes 152a may be disposed at other locations, for example, at the junction of the front wall 160 and the side wall 166, or at the junctions of the side walls 164, 166 with the rear wall 162. Collectively, the through-holes 152a may embody drainage ports for discharging moisture accumulation (e.g., water) from the recessed tray 150 to an exterior of the power source 110. In particular, any moisture that has been collected in the recessed tray 150, may follow a drainage path defined by the channel 180, wherein the channel 180 is defined by the flange 141 of the top panel 140, the bent lip 145, and the side panel 144 (or 146). For instance, liquid may first flow through the through-hole 152a and into the space S defined by the flange 141 and the bent lip 145, whereupon the liquid may drain from the space S to an exterior of the power source 110 via the gap G between the bent lip 145 and the flange 141. In this manner, the through-hole 152a, the space S, the gap G, and the exterior side of the side panel 144 may collective define the channel 180 to direct moisture or liquid away from the tray 150 to an exterior of the power source, e.g., to the surrounding environment.

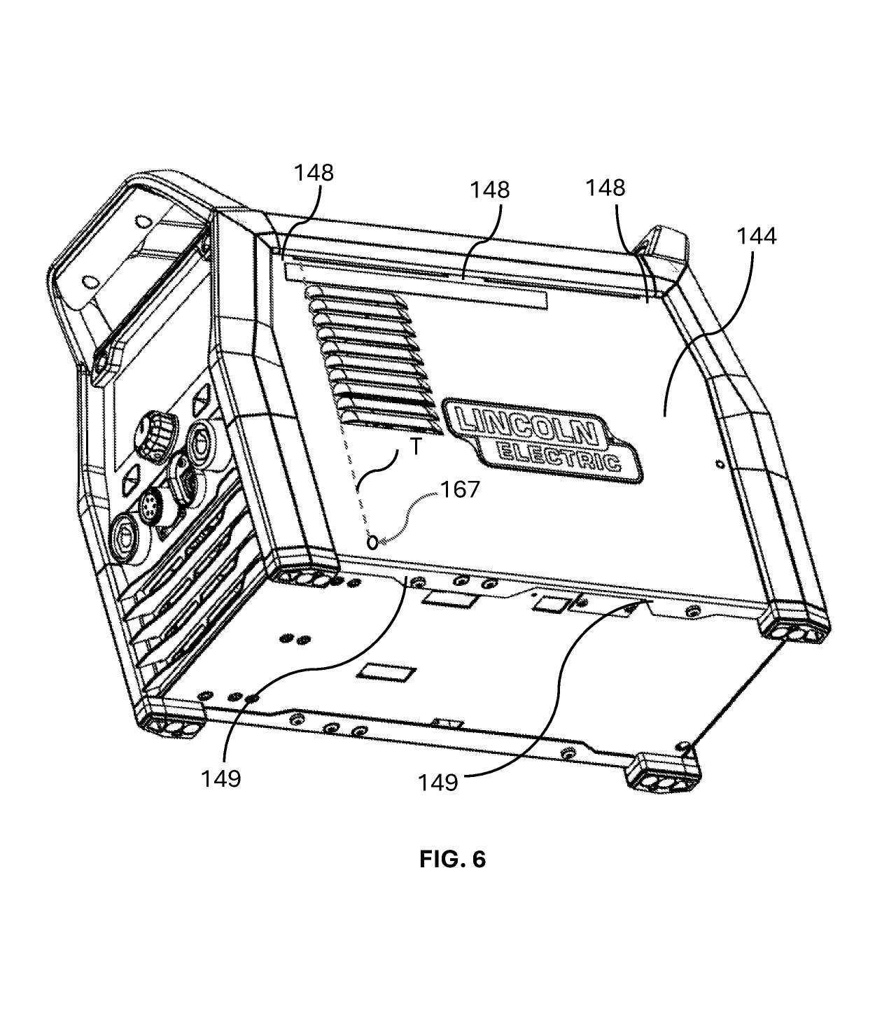

In particular, the bent lip 145 may define a contour to guide liquid in a direction away from the cavity 130a, such that any liquid accumulation be directed to the external environment (outside of the power source). Accordingly, the flange 141 and the bent lip 145 may be shaped and configured to direct liquid accumulation away from the cavity 130a, to prevent ingress into the internal electronics of the power source 110. In the embodiment shown, a liquid discharge channel 180 is shown between side panel 144 and the top panel 140. It should be understood that side panel 146 and the top panel 140 may alternatively or additionally define a liquid discharge channel, and that more than one channel may be formed (e.g., based on the provisional of additional holes 152a). In some embodiments, a removable gasket or seal 147 (FIG. 4) may be disposed on the upper end of the bent lip 145 so as to be disposed between the bottom wall 152 of the recessed tray 150 and the bent lip 145, to further inhibit moisture ingress into the cavity 130a of the power source 110. In some embodiments, the channel 180 may comprise a flexible tube T (FIG. 6) that extends through the channel 180 from a respective through hole (e.g., 152a) to a designated collection area or discharge port, for example, a discharge port 167 formed through a respective side panel). In this manner, it should be appreciated that numerous channel configurations for directing liquid away from the tray are contemplated and fall within the scope of the present disclosure.

As shown in FIGS. 6 and 7, the tabs 148 of each side panel 144 or 146 may be dimensioned and positioned to engage corresponding slots 141c defined by the downwardly projecting flanges 141 of the top panel 140. This configuration enables simplified installation of the side panels 144, 146 on the power source 110 with fewer fastening locations (e.g., screws or rivets). This aspect also helps minimize potential liquid ingress locations (e.g., where the screws or rivets fasten to the power source enclosure).

Each side panel 144, 146 may be secured by inserting the tabs 148 into the respective slots 141c and removably attaching the bent leg 149 at the lower end of the respective panel to the bottom wall or chassis of the power source 110. The lower end may be removably attached to the bottom wall or chassis via any suitable attachment means, for example, via a tongue and groove or slot and tab mechanism, via snaps, clips, removable fasteners, and the like. By reducing the number of fastener locations via the tabs 148 and slots 141c, the side panels may be more easily installed, removed, or reassembled, reducing assembly time and minimizing the number of fasteners required.

Turning now to FIG. 8, another exemplary embodiment of a GTAW welding system 20 is shown. The GTAW welding system 20 includes similar features as system 10. Accordingly, a description of similar features has been omitted for brevity, except for the differences noted below. Further still, similar reference numbers will be used to depict similar features.

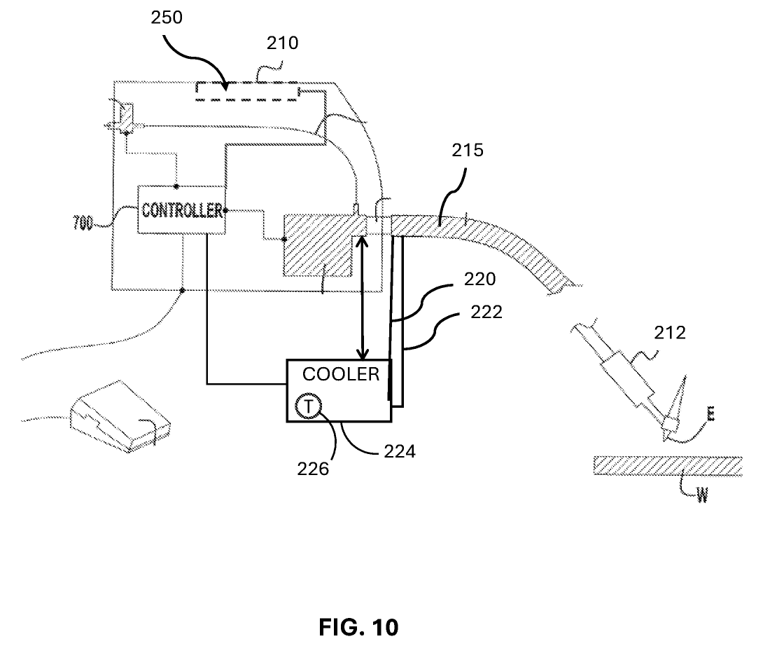

As shown in FIG. 8, the welding system 20 includes a power source 210 and a cooler 224 configured to recirculate coolant to and from a GTAW welding torch (212 in FIG. 10), as discussed in detail below. In the embodiment shown, the bottom wall 252 of the recessed tray 250 defines one or more pass-through drainage openings in the form of slots 252a.

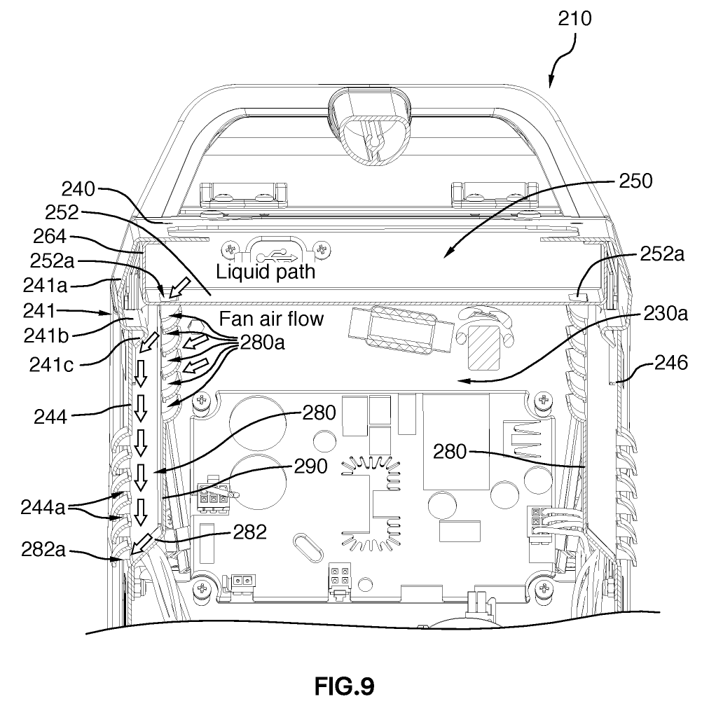

Referring to FIG. 9, a channel 280 for directing moisture or liquid away from tray 250 according to another embodiment will now be described. The following description pertains to the channel 280 shown on the left-hand side of the drawing, although it should be understood that the same description applies equally to the channel 280 shown on the right-hand side.

In this embodiment, an internal partition wall 290 is attached to a side panel 244 of the power source 210 (such that the partition wall 290 is disposed adjacent to the internal cavity 230a). The partition wall 290 may include one or more openings 280a (e.g., louvers) that allow fan-driven air from a fan (not shown) from the internal cavity 230a to flow through the openings 280a, and into a channel 280 between the partition wall 290 and the side panel 244. This air may then be exhausted through additional openings 244a (e.g., louvers) formed in the side panel 244.

A flange 241 may extend downward from the top panel 240 and include a first segment 241a projecting downward from the top panel 240, a second segment 241b extending inward (toward the internal cavity 230a) from the lower end of the first segment 241a, and a third or bent segment 241c bent outward (toward the exterior of the power source 210).

In this embodiment, the partition wall 290, side panel 244, and flange 241 collectively define the channel 280, which is configured to direct liquid (entering through drainage opening 252a) toward the exterior of the side panel 244, as illustrated by the liquid path in FIG. 9. The bent segment 241c is shaped and configure to promote capillary adhesion of the liquid, causing the liquid to adhere to the side panel 244 and exit through an outlet 282a of the channel 280 extending through the side wall 244. When the power source 210 is operational, fan-driven air entering the openings 280a of the partition wall 290 may blow any liquid entering the drainage opening 241a against the side panel 244, thereby at least partially drying the liquid and/or enhancing its adhesion to the side panel 244.

Furthermore, in the event that liquid from an external environment (i.e., outside of the power source 210) were to come into contact with the side panel 244, and enter the channel 280 through the openings 244a and/or the outlet 282a of the side panel 244, the partition wall 290 is devised to prevent any such liquid from entering the internal cavity 230a. This is achieved via a solid portion 291 of the partition wall 290 that is devoid of openings 280a.

In the embodiment shown, the partition wall 290 defines five openings 280a. It is contemplated that the number of openings may vary, and in some embodiments, the partition wall may be entirely devoid of openings. Further still, it is contemplated that a tube (e.g., T in FIG. 6) may be routed from the drainage opening 252a to the outlet 282a.

Referring to FIG. 10, coolant lines 220, 222 may extend from the cooler 226 to a torch cable assembly 215 extending between the power source 210 and a torch 212 (e.g., a liquid-cooled TIG torch). In this manner, the coolant lines 220, 222 may be routed through the torch cable assembly to a head of the torch 212.

The coolant lines 220, 222 may be dimensioned to recirculate a coolant (e.g., water) to and from the torch 212, thereby cooling the torch 212 to prevent thermal failure caused by heat dissipated during welding operations. For this purpose, the cooler 224 may include a heat exchanger (not shown) for extracting heat from the coolant circulated back to the cooler 226 from the torch 212. The cooler 224 may also include a pump (not shown) that supplies coolant to the torch 212 (e.g., via the port 220a (FIG. 8) and coolant line 220 (FIG. 10) fluidly connected thereto), whereupon the coolant is recirculated back to the cooler (e.g., via coolant line 222 (FIG. 10) and port 222a (FIG. 8))) for re-cooling via the heat exchanger.

In the illustrated embodiment, the cooler 224 includes a temperature sensor 226 configured to measure the temperature of the coolant returning from the torch 212. The temperature sensor 226 may be positioned on one of the recirculating coolant lines 220 or 222 to measure the temperature of the coolant supplied to the torch 212, or the coolant returning from the torch 212. The welding power supply 210 may also include a controller 700 operatively connected to the cooler 224 to activate and deactivate the cooler 224. The controller 700 may comprise logic to receive temperature measurements from the cooler 224 (via the sensor 226) and adjust cooler operation accordingly. For example, if the coolant temperature exceeds a predetermined threshold, the controller 700 may extend the cooler’s run time (e.g., after the welding arc is extinguished) to ensure adequate cooling of the torch 212. Conversely, if the coolant temperature is within an acceptable range, the controller 700 may reduce the cooler’s run time. In certain embodiments, the controller 700 may also adjust the speed of a fan within the cooler 224 based on the measured coolant temperature.

In some embodiments, the cooler 224 may include a docking port for operatively connecting the cooler to the power source (e.g., to receive power from the power source). The docking port may include a resilient connector configured to snap onto a mating connector on the bottom surface of the welding machine, thereby securely coupling the cooler to the power source.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A power source comprising:
an enclosure defining an internal cavity for housing electronics, wherein the enclosure comprises a plurality of panels including a top panel and a side panel,
wherein the top panel includes a tray defining a storage area, and wherein a drainage opening is formed through the tray and is configured to allow liquid within the tray to drain therethrough and be directed out of the tray.

2. The power source of claim 1, wherein the enclosure includes a channel adjacent to the side panel and fluidly connected to the drainage opening, wherein the channel is configured to direct the liquid toward an exterior of the power source.

3. The power source of claim 2, wherein the enclosure includes a partition wall attached to the side panel, wherein the partition wall and the side panel at least partly define the channel.

4. The power source of claim 2, wherein the enclosure includes a partition wall attached to the side panel, wherein the partition wall defines an opening extending between an internal cavity of the power source and the channel.

5. The power source of claim 2, wherein the top panel includes a flange extending downward therefrom, wherein the flange includes:
a first segment extending downward from the top panel,
a second segment extending inward from the first segment, and
a third segment bent relative to the second segment.

6. The power source of claim 1, wherein the side panel includes a bent lip at an upper end thereof, and wherein the top panel includes a flange extending downward therefrom, wherein the bent lip and the flange at least partly define the channel.

7. The power source of claim 1, wherein the tray is recessed relative to an upper surface of the top panel.

8. The power source of claim 1, wherein at least one connector is disposed on a wall of the recessed tray, wherein the connector is operatively connected to the electronics within the enclosure, and wherein the connector is configured to provide at least one of data communication or power delivery to an external device.

9. The power source of claim 1, wherein the tray comprises a bottom wall and a plurality of walls extending upwardly therefrom that collectively define the storage area, and wherein the drainage opening comprises a slot formed adjacent a junction of the bottom wall and one of the plurality of walls.

10. The power source of claim 1, wherein the side panel includes a tab at an upper end thereof, wherein the top panel includes a flange extending downward therefrom, wherein the flange defines an opening, and wherein the tab is dimensioned and configured to be received by the opening of the flange to removably attach the side panel to the power source.

11. The power source of claim 1, wherein the channel further comprises a tube extending from the drainage opening to a discharge port formed through the side panel of the enclosure.

12. A welding system comprises:
a power source configured to supply a welding current or laser beam, wherein the power source includes an enclosure, and wherein the enclosure includes:
at least a top panel and a side panel that at least partly define an internal cavity of the power source, and
a tray attached to the top panel and defining a drainage opening for liquid therethrough; and
a welding torch operatively connected to the power source and configured to emit the welding current or the laser beam.

13. The welding system of claim 12, wherein the enclosure includes a partition wall in the internal cavity attached to the side panel, wherein the partition wall and the side panel at least partly define a channel fluidly connected to the drainage opening.

14. The welding system of claim 12 further comprising a cooler operatively connected to the welding torch, wherein the cooler is configured to cool and recirculate a coolant to the welding torch.

15. The welding system of claim 14, wherein the welding system includes a controller, and wherein the controller comprises logic to:
receive a temperature measurement of the coolant, and
control a run time of the cooler based on the temperature measurement.

16. The welding system of claim 15, wherein the controller further comprises logic to extend the cooler run time after termination of a weld or when the temperature measurement of the coolant exceeds a threshold.

17. The welding system of claim 14, wherein the cooler includes a docking port configured to operatively connect to the power source to receive power therefrom and to transmit the temperature measurement therebetween.

18. The welding system of claim 12, wherein the tray further comprises a friction surface disposed on the bottom wall to prevent items from sliding within the tray.

19. The welding system of claim 12, wherein the tray further comprises a wireless charging surface integrated into a bottom wall thereof.

20. The welding system of claim 12, wherein a flange extends downward from the top panel, wherein the flange includes:
a first segment extending downward from the top panel,
a second segment extending inward from the first segment, and
a third segment bent outward relative to the second segment.
